(19) United States
(12) Patent Application Publication
(10) Pub. No.: US 2006/0218834 A1
(43) Pub. Date: Oct. 5, 2006

(54) Mini reminders

(76) Inventor: Alice R. Pitts, Lanett, AL (US)

Correspondence Address: LITMAN LAW OFFICES, LTD, PO BOX 15035, CRYSTAL CITY STATION, ARLINGTON, VA, 22215, US

(21) Appl. No.: 11/393,856

(22) Filed: Mar. 31, 2006

Related U.S. Application Data
(60) Provisional application No. 60/667,059, filed on Apr. 1, 2005.

(51) Int. Cl. G09F 7/00

(52) U.S. Cl. 40/597

(57) ABSTRACT

A reminder display includes a small, transparent, plastic case, which case houses a pre-printed reminder note therein. The case is mounted on the end of a mounting device such as a suction cup. The mounting device can be removably secured to almost any planar surface (refrigerator door, cabinet wall, automobile windshield, etc.).

### CROSS-REFERENCE TO RELATED APPLICATION

This application claims the benefit of U.S. Provisional Patent Application Ser. No. 60/667,059, filed Apr. 1, 2005.

### BACKGROUND OF THE INVENTION

1. Field of the Invention

The present invention generally relates to display devices. More specifically, the present invention is drawn to a device for displaying reminder notes.

2. Description of the Related Art

There are many instances when a reminder is needed to jostle a person's memory regarding a chore or task that needs to be done. Often these reminders are in the form of a note left in the car, disposed on the kitchen table, attached to the refrigerator, etc. Many times it is impossible to find a sheet of paper, a notepad or a pen to execute the reminder note. It would certainly be advantageous if there were a supply of pre-printed reminder notes and a handy system to prominently display the notes.

The related art is replete with memo display devices. Examples of these devices are cited and identified in the accompanying IDS. However, none of the cited and identified inventions and patents, taken either singly or in combination, is seen to disclose a display device for memos as will be subsequently described and claimed in the instant invention.

### SUMMARY OF THE INVENTION

In the preferred embodiment, the instant invention (to be dubbed “mini reminders”) includes a small, transparent, plastic case, which case houses a pre-printed reminder note therein. A hook provides means to attach the case to a small suction cup. The suction cup can be removably secured to almost any planar surface (refrigerator door, cabinet wall, automobile windshield, etc.).

Accordingly, the instant invention presents a unique memo-display assembly that is simplistic and efficient. The invention provides for improved elements and arrangements thereof for the purposes described which are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a memo display assembly according to the present invention.

FIG. 2 is an exploded, perspective view of a memo display assembly according to the present invention.

FIG. 3 is a side view of a second embodiment of a memo display assembly according to the present invention.

FIG. 4 is a perspective view of a third embodiment of a memo display assembly according to the present invention.

FIG. 5 is a side view of a second embodiment of a memo display assembly according to the present invention.

FIG. 6 is a rear view of a third embodiment of a memo display assembly according to the present invention.

FIG. 7 is a perspective view of a kit for housing a plurality of disks and/or messages of a memo display assembly according to the present invention.

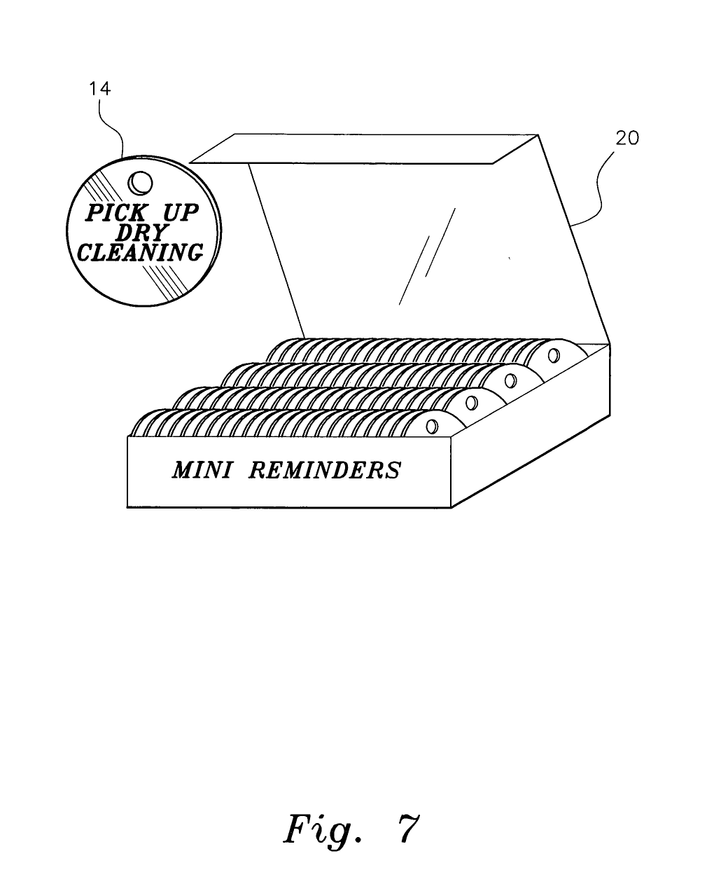

Similar reference characters denote corresponding features consistently throughout the attached drawings.

### DETAILED DESCRIPTION OF THE PREFERRED EMBODIMENTS

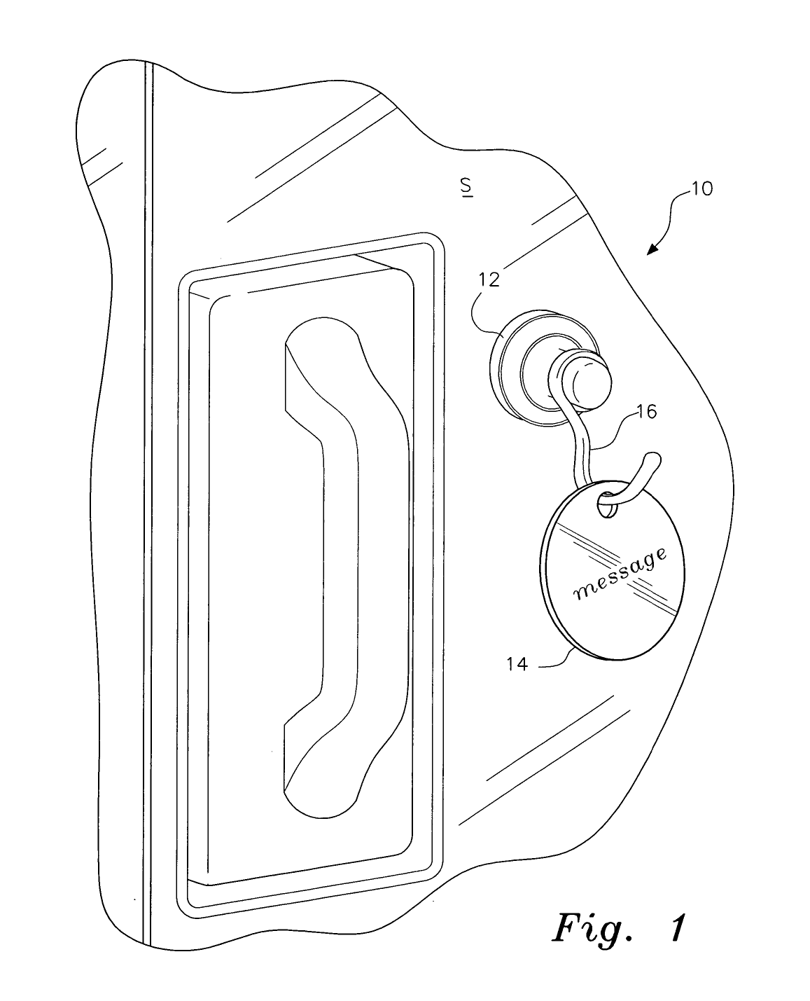

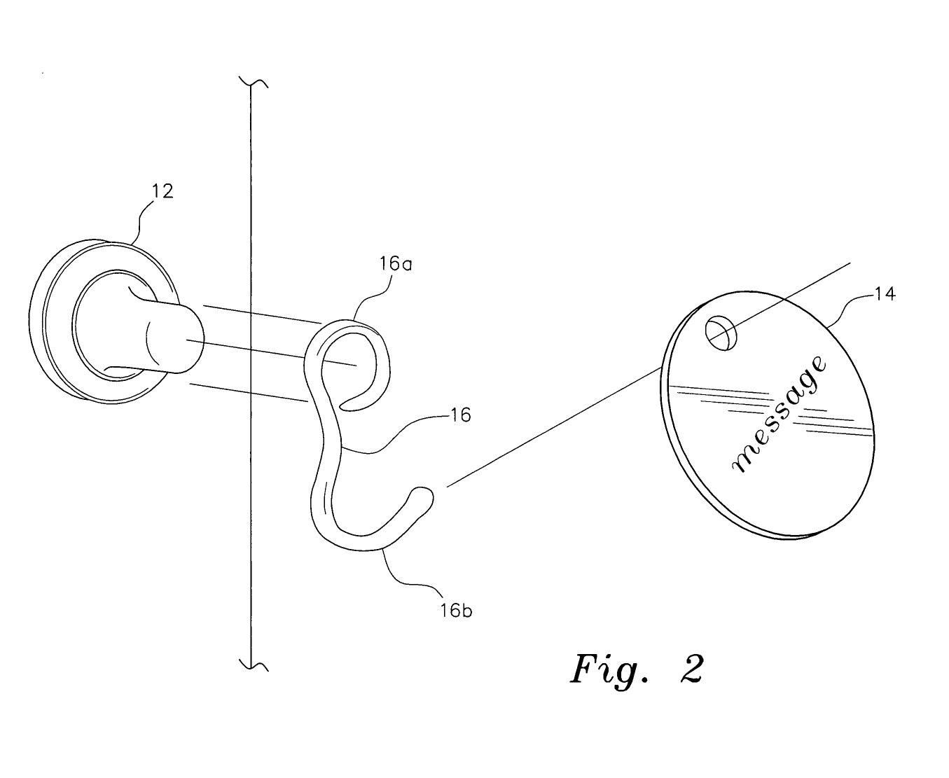

Attention is first directed to FIGS. 1 and 2 wherein a first embodiment of “mini reminders” is generally indicated at 10. The instant invention comprises a suction cup 12, which cup is adapted to be removably secured to a planar surface S. Surface S may take on almost any form such as a refrigerator or cabinet door, wall, mirror, automobile windshield, etc. A transparent disk 14 is removably attached to one end of suction cup 12. A hook 16 is utilized to attach the transparent disk to the suction cup. Hook 16 has a proximate end 16a that is secured to the end of the suction cup in any convenient manner. The distal end 16b of the hook removably supports disk 14 thereon. Disk 14 houses a pre-printed message or reminder therein. Pre-printed reminders are made available for the user. “Feed The Dog”, “Call Your Father”, “Go By The Bank” are samples of the multitude of pre-printed reminders that can be employed. Each disc can permanently enclose a pre-printed reminder or a specific reminder may be removed from the disk and interchanged with a different reminder.

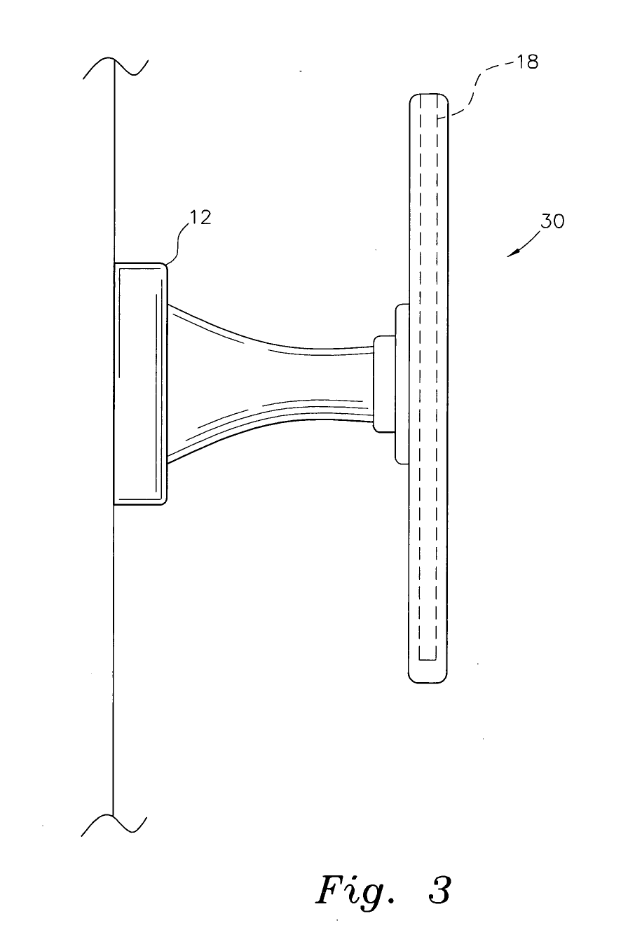

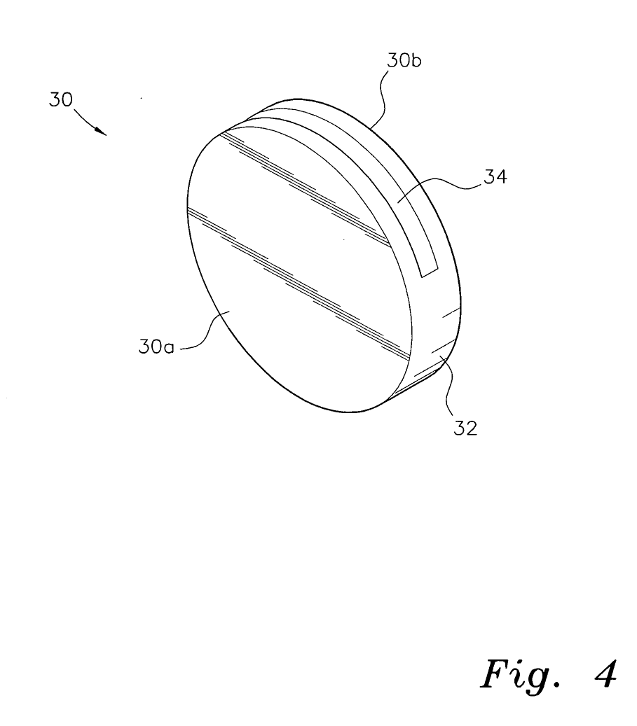

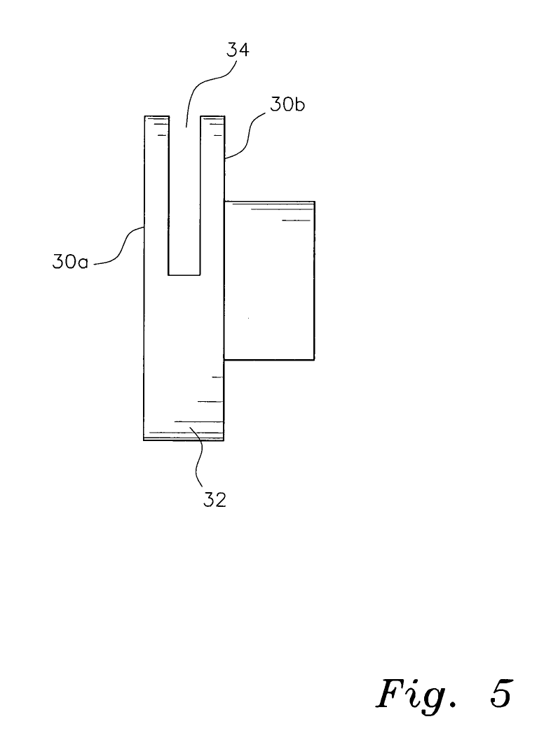

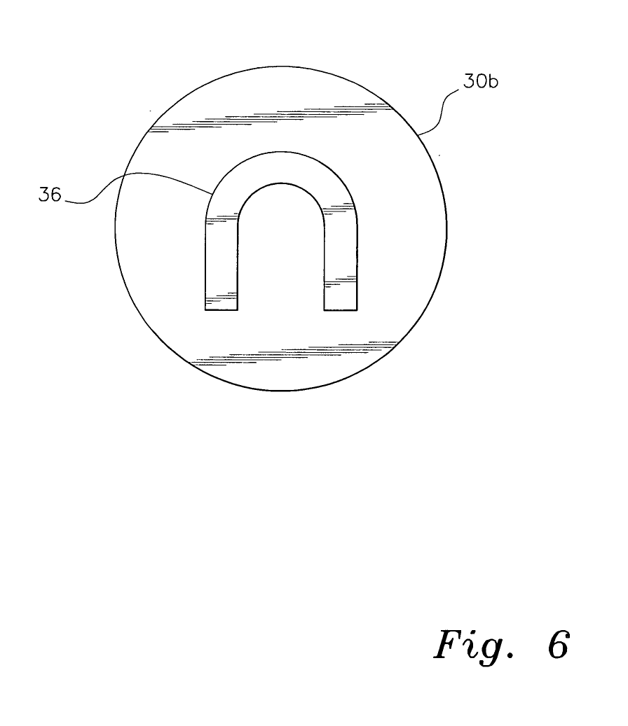

FIGS. 3-6 illustrate an alternative to the embodiment described above. The transparent disk 30 is secured directly to the suction cup 12. A pre-printed message 18 (shown in phantom lines) can be removably inserted into disk 30. The instant embodiment eliminates the hook and would lower production costs. As best seen in FIGS. 4 and 5, disk 30 is fabricated from transparent material and comprises a front surface 30a spaced from a rear surface 30b defining an open volume therebetween. A closure 32 spans the space between surfaces 30a and 30b adjacent their lower perimeters, thereby closing the space at the lower perimeters. Slot 34 is thus formed for receiving the pre-printed messages. A U-shaped member 36 is disposed on the rear face of surface 30b for receiving an end of the suction cup 12 therein. Although the disk 30 is illustrated as circular it should be noted that other configurations (square, hexagonal, etc.) may be utilized if desired. It should also be recognized that magnetic material can be utilized to make the attachment in lieu of a suction cup.

As presently contemplated, the invention can be merchandised as a kit 20, which kit will house all components therein including an array of pre-printed messages and/or disks 14. The user may employ plural disks to leave any number of mini reminders at different locations.

It is to be understood that the present invention is not limited to the embodiments described above, but encompasses any and all embodiments within the scope of the following claims.

I claim:

1. A mini reminder, comprising:
a mounting device, said mounting device having a rear end and a front end;
a transparent disk, said transparent disk having an inner volume, said transparent disk being secured to the front end of said mounting device; and
a pre-printed reminder memo, said pre-printed reminder memo housed in said inner volume.

2. The mini reminder according to claim 1, wherein said mounting device is a suction cup.

3. The mini reminder according to claim 1 further including a hook member securing said transparent disk to the front end of said mounting device.

4. The mini reminder according to claim 1, further including a hook member securing said transparent disk to the front end of said mounting device, said hook member having a proximate end and a distal end, wherein said proximate end is attached to said front end of said mounting device and wherein said transparent disc is removably mounted on said distal end.

5. The mini reminder according to claim 4, wherein said mounting device is a suction cup.

6. A mini reminder, comprising:
a mounting device, said mounting device having a rear end and a front end;
a transparent disk, said transparent disk having a front surface and a rear surface spaced from said front surface defining an inner volume therebetween, said transparent disk being secured to the front end of said mounting device; and
a pre-printed reminder memo, said pre-printed reminder memo removably housed in said inner volume.

7. The mini reminder according to claim 6, wherein said mounting device is a suction cup.

8. A mini reminder according to claim 6, wherein said rear surface has a rear face and including a U-shaped mounting member disposed on said rear face for receiving the front end of said mounting device.

9. A mini reminder, comprising:
a suction cup, said suction cup having a rear end and a front end;
a transparent disk, said transparent disk having a front surface and a rear surface spaced from said front surface defining an inner volume therebetween, said rear surface having a rear face;
a U-shaped mounting member disposed on said rear face for receiving the front end of said suction cup; and
a pre-printed reminder memo, said pre-printed reminder memo removably housed in said inner volume.
